(19) United States
(12) Patent Application Publication
(10) Pub. No.: US 2015/0343565 A1
(43) Pub. Date: Dec. 3, 2015

(54) METHOD OF FORMING FEATURE ON TUBE

(71) Applicant: Caterpillar Inc., Peoria, IL (US)

(72) Inventor: Marchione T. Andre, Heber, UT (US)

(73) Assignee: Caterpillar Inc., Peoria, IL (US)

(21) Appl. No.: 14/824,099

(22) Filed: Aug. 12, 2015

(51) Int. Cl. B23K 26/34; B23K 26/38

(52) U.S. Cl. CPC B23K 26/345; B23K 26/381; B33Y 10/00

(57) ABSTRACT

A method of forming a feature on a tube having a wall is provided. The wall defines an outer surface and an inner surface. The method includes forming, via a processing device, a Three Dimensional (3D) model of the feature. The method further includes slicing, via the processing device, the 3D model of the feature into a plurality of model layers. The method also includes regulating, via the processing device, a dispensing member to deposit a plurality of layers of a material on the outer surface of the tube to form the feature. The plurality of layers of the material correspond to the plurality of model layers. The method further includes forming, via a machining process, a hole in the wall of the tube to communicate an interior of the feature with an interior of the tube.

### TECHNICAL FIELD

The present disclosure relates to a method of forming a feature on a tube.

### BACKGROUND

Fluid conduits, for example ducts, hoses, and pipes, are generally used to supply and control flow of fluids. The fluid conduits can have complex shapes and/or surface features which are typically machined from a wall of such conduits. Such fluid conduits can be exposed to corrosive environment such as in a gas turbine engine. The fluid conduits employed in such machines need to be connected to external components for example measuring systems such as thermocouples, pressure gauges, etc. to measure various properties of the fluid. The fluid conduits are connected to the measuring systems via various methods such as threading and adhesives. The conduits connected with such methods can cause a leakage and thus failure of such fittings. Moreover, the measuring devices connected via such method can give faulty readings due to the leakage of the fluid flowing through the conduits.

For reference, US Patent Publication 2002/020164 (the '164 publication) discloses a metal article of manufacture including a tubular body portion and free-formed metal features on the tubular body portion. The free-formed metal features are formed of a layer wise deposition of a molten metal material in a predefined pattern to form the desired free-formed feature or construction. However, the features of the '164 patent can not be used to connect various external components with the tubular body.

### SUMMARY OF THE DISCLOSURE

In an aspect of the present disclosure, a method of forming a feature on a tube having a wall is provided. The wall defines an outer surface and an inner surface. The method includes forming, via a processing device, a Three Dimensional (3D) model of the feature. The method further includes slicing, via the processing device, the 3D model of the feature into a plurality of model layers. The method also includes regulating, via the processing device, a dispensing member to deposit a plurality of layers of a material on the outer surface of the tube to form the feature. The plurality of layers of the material correspond to the plurality of model layers. The method further includes forming, via a machining process, a hole in the wall of the tube to communicate an interior of the feature with an interior of the tube.

Other features and aspects of this disclosure will be apparent from the following description and the accompanying drawings.

### BRIEF DESCRIPTION OF THE DRAWINGS

FIG. 1 illustrates a block diagram of a system, according to an embodiment of the present disclosure;

FIG. 2 is a flowchart for a method of forming a feature on the tube, according to an embodiment of the present disclosure;

FIG. 3 illustrates a partial sectional view of the tube showing a virtual 3D model of the feature, according to an embodiment of the present disclosure;

FIG. 4 illustrates a partial section view of the feature showing a plurality of layers, according to an embodiment of the present disclosure;

FIG. 5 illustrates a sectional view of the feature, according to an embodiment of the present disclosure; and

FIG. 6 illustrates a partial section view of the tube showing a hole in a wall of the tube, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

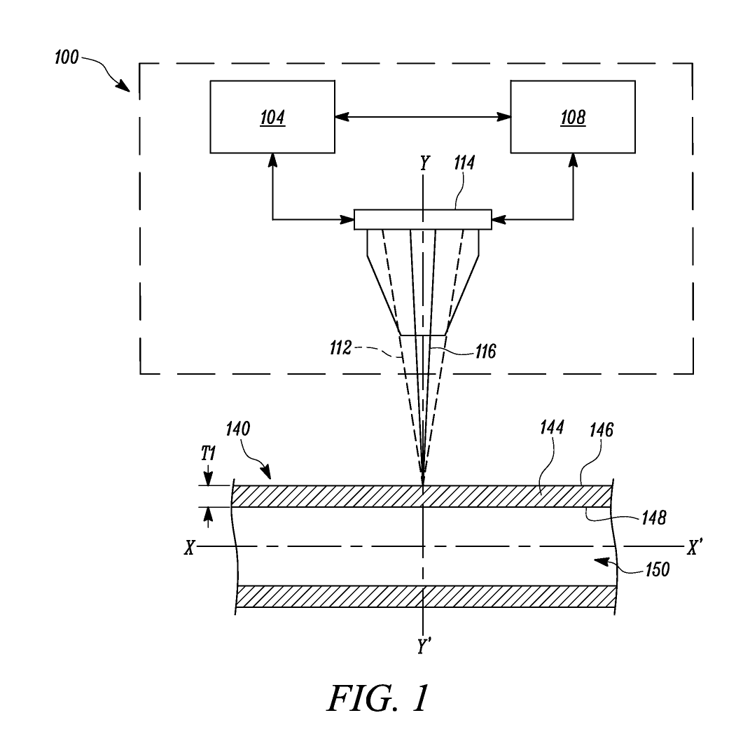

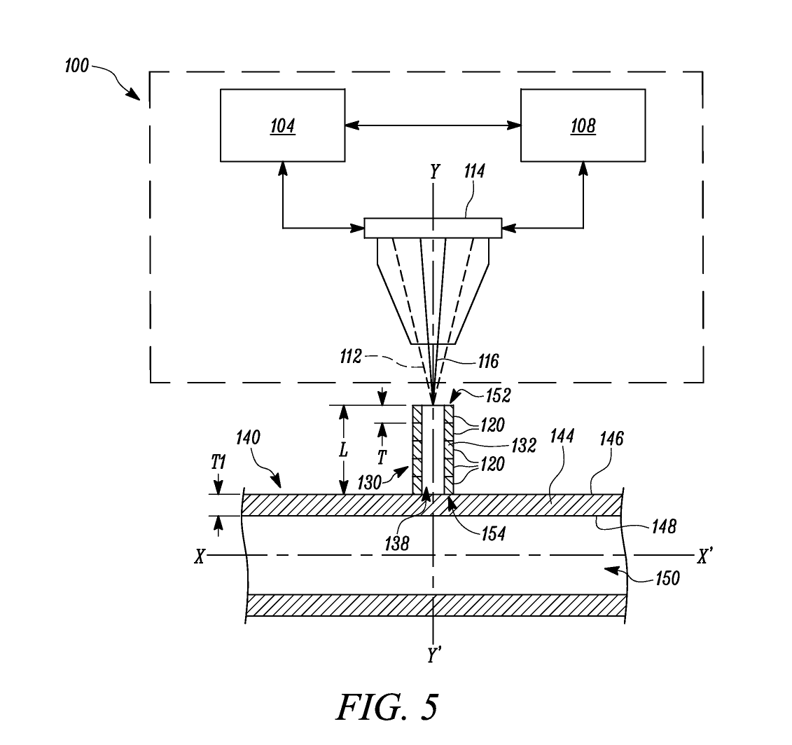

FIG. 1 is a block diagram of a system 100 for forming a feature 130 (shown in FIG. 5) on a tube 140, according to an embodiment of the present disclosure. The tube 140 is configured to supply a flow of fluid flowing therethrough. The tube 140 is installed in a machine (not shown) such as gas turbines, but not limited thereto, for supplying a flow of gas to various components of the machine (not shown). The tube 140 can also be fluidly connected to a number of sensing units (not shown) such as thermocouples and pressure gauge . The sensing units is configured to measure a property of the fluid flowing therethrough. In the illustrated embodiment, the tube 140 has a hollow cylindrical shape having a diameter which is uniform throughout a length of the tube 140. However, the tube 140 can also be tapered for controlling a flow of fluid flowing therethrough. In an alternate embodiment, the tube 140 can be a curved tube. In yet another embodiment, the tube 140 can also include a complex geometrical shape for example, bends and branches,.

The tube 140 includes a first wall 144 defining an outer surface 146 and an inner surface 148. The first wall 144 has a thickness ‘T1’ extending between the outer surface 146 and the inner surface 148. The tube 140 further defines a longitudinal axis XX′, and a transverse axis YY′ perpendicular to the longitudinal axis XX′. The tube 140 further defines a first interior cavity 150 therethrough. The first interior cavity 150 is configured to receive a flow of fluid from a system (not shown) of the machine therethrough.

Referring to FIG. 1, the system 100 can be any mobile or immobile equipment configured to form the feature 130 on the outer surface 146 of the tube 140. The system 100 can be any additive manufacturing based system for forming the feature 130 (FIG. 5) pursuant to the process of the present disclosure. An additive manufacturing process associated with the system can include laser cladding, electron beam welding, and/or the like. However, in various alternate embodiments, the system 100 can also be based on any welding process, such as tungsten inert gas welding, for forming the feature 130 pursuant to the process of the present disclosure.

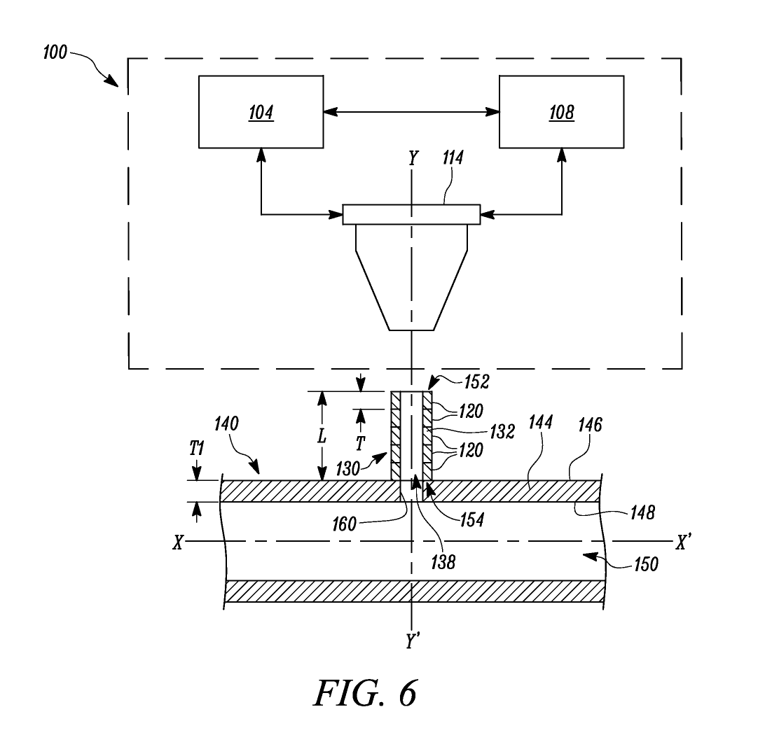

The system 100 is based on a laser cladding process. The system 100 includes a laser head 114. The laser head 114 is configured to irradiate a laser 116 onto a predetermined work area. In an embodiment, the predetermined work area can correspond to a region on the outer surface 146 of the tube 140 where the feature 130 is to be formed based on a type of application of the feature. In the illustrated embodiment, the predetermined work area is shown as a region surrounding a hole 160 (shown in FIG. 6) on the outer surface 146 of the tube 140. However, the predetermined work area can correspond to any region on the tube 140 where a duct of the measuring device is to be coupled.

Further, the laser head 114 can include a light emitting unit, an oscillating unit, an optical element such as an optical fiber, and a focusing unit. The components of the laser head 114 are known in the art and not shown in FIG. 1. The oscillating unit is configured to oscillate the laser 116 at a specified frequency. The laser 116 at the specified frequency is transmitted through the optical element to the laser focusing unit. At the focusing unit, the laser 116 is focused, and irradiated to the predetermined work area via the laser emitting unit.

Further, the laser 116 can operate in different modes such as, a continuous mode of operation and a pulse mode of operation based on the frequency of the laser 116 depending on a signal/command received from the processing device 104. The laser 116 in the continuous mode of operation can be pulsed at a pre-determined frequency to obtain the laser 116 in the pulse mode of operation. The laser 116 can acts as a source of heat which in turn melts the material on the predetermined work area to form a fusion bond between the tube 140 and the material lying thereupon.

The system 100 includes a processing device 104 capable of giving and receiving modeling and analyzing instructions associated with forming of the feature 130. For example, the processing device 104 can receive modeling and analyzing instructions from a Graphical User Interface (GUI). The processing device 104 can also be configured to receive command signals from the GUI and accordingly actuate various components of the system 100. The processing device 104 can embody a single microprocessor or multiple microprocessors configured for receiving signals from the components of the system 100. Numerous commercially available microprocessors can be configured to perform the functions of the processing device 104.

The system 100 further includes a dispensing member 108 operably coupled to the processing device 104. The dispensing member 108 can receive commands/signals from the processing device 104. The dispensing member 108 receives and delivers a material based on a command/signal received from the processing device 104. In an embodiment, the dispensing member 108 receives the material from a reservoir (not shown) and delivers a stream 112 of the material received from the reservoir to the outer surface 146 of the tube 140. Specifically, the dispensing member 108 delivers the stream 112 of the material at a location at which the laser 116 impinges upon the outer surface 146 of the tube 140. In an example, the dispensing member 108 is coupled to the laser head 114 to facilitate such a configuration. However, in various alternate embodiments, the dispensing member 108 and the laser head 114 can be separately mounted on a translation unit. Further, the dispensing member 108 also includes multiple feeding tubes (not shown) arranged to directly deliver the stream 112 of the material to the outer surface 146 of the tube 140.

The system 100 can be capable of utilizing a material such as steel, plastic, ceramics and composites, but are not limited thereto. The material can be different or similar to a material of the tube 140. Further, the material to be deposited can be selected based on type of application of the feature 130 to be formed on the tube 140. A type or nature of the materials is non-limiting of this disclosure. One of ordinary skill in the art can beneficially contemplate using any type or nature of material depending on specific requirements of the application and without deviating from the spirit of the present disclosure.

Although the system disclosed herein is based on laser cladding process, it will be appreciated that in an alternate embodiment, the system can be based on other processes, for example tungsten inert gas welding. In such a case, the system can include a weld head configured to generate an electric arc on a predetermined work area. The system can also include a dispensing device configured to supply a material on the predetermined area on the outer surface 146 of the tube 140. The dispensing device of the system can supply the material via a filler rod. The system can also include a translation system that can allow the weld head and the dispensing device to move independently of one another. Any type of translation system commonly known in the art can be suitably employed to implement an independently movable relation between the weld head and the dispensing device. Further, the electric arc can act as a source of heat which in turn melts the material on the predetermined work area to form a fusion bond between the tube 140 and the material lying thereupon.

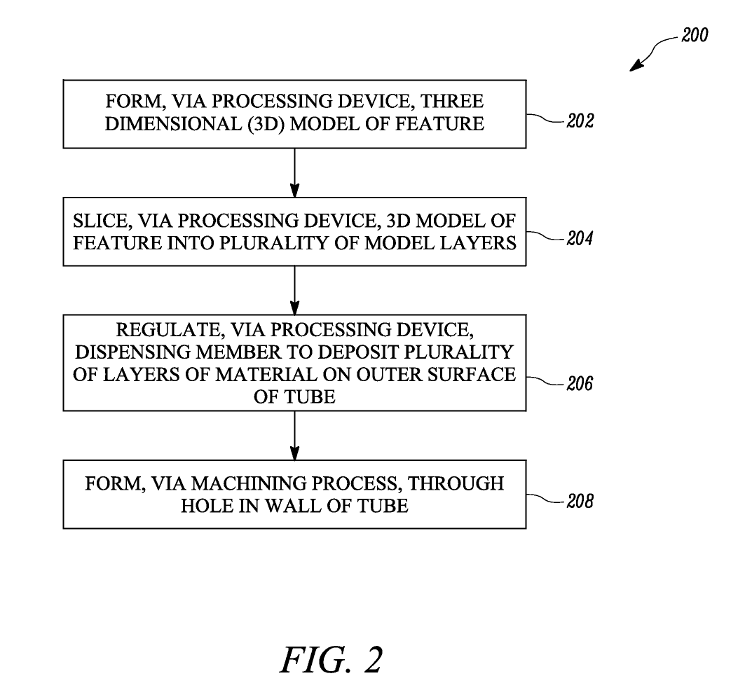

Referring to FIG. 2, a flow chart for a method 200 of forming the feature 130 on the tube 140 is illustrated. As shown in FIG. 5, the feature 130 is a cylindrical shaped three dimensional structure formed by the system 100. The feature 130 includes a second wall 132 extending to a length “L” corresponding to a distance between a first end 152 and a second end 154 of the feature 130. The second end 154 is adjacent to the second wall 132. The second wall 132 further defines a second interior cavity 138 therebetween. The structure of the feature 130 as described is exemplary, can assume any other geometrical shape such as solid cylinder, cuboid and the like.

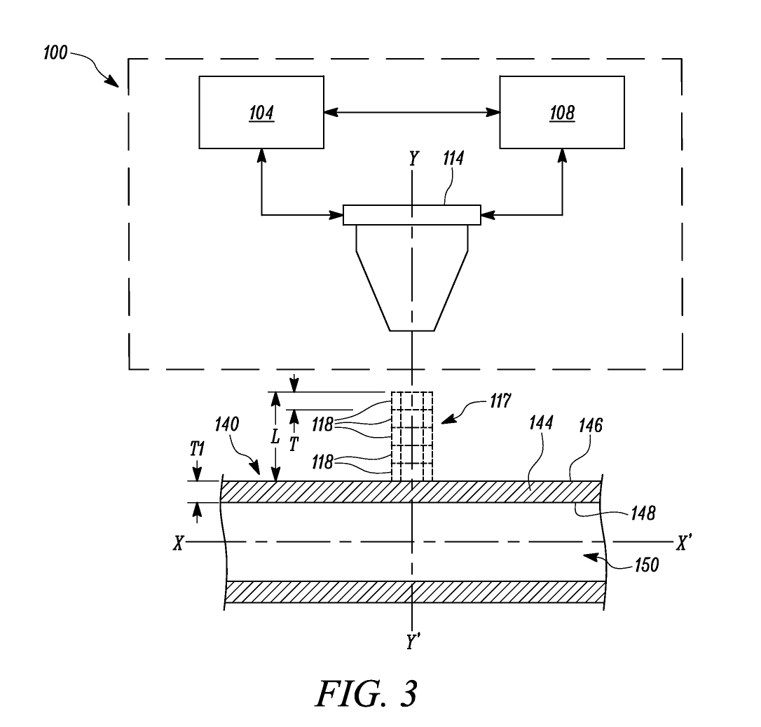

Referring to FIGS. 3 to 6, various steps of the method 200 implemented on the outer surface 146 of the tube 140 are illustrated. In an embodiment, the method 200 can be a computer-implemented method. The processing device 104 of the system 100 is programmed to implement the method 200.

At step 202, the method 200 includes forming, via the processing device 104, a Three Dimensional (3D) model 117 of the feature 130. In an embodiment, the processing device 104 can generate the 3D model 117 based on a set of geometrical dimensions received from the GUI. However, in various alternate embodiment, the processing device 104 can also be communicably coupled to an image capturing module (not shown) which captures one or more images of the feature to be formed. Various routines, algorithms, and/or programs can be programmed within the processing device 104 for execution thereof to generate the 3-D model 117 of the feature 140 to be formed.

At step 204, the method 200 includes slicing the 3D model 117 of the feature 130 into a plurality of model layers 118. The processing device 104 is programmed to slice the 3D model 117 of the feature 130 into the model layers 118. As shown in FIG. 3, the feature 130 is segmented into five distinct model layers 118 based on the length “L” of the 3D model 117 of the feature 130. In the illustrated embodiment, the feature 130 is segmented into five disc shaped model layers having an individual predetermined thickness “T”. A sum of each of the predetermined thickness ‘T’ of each of the model layers 118 is substantially equal to the length “L” of the 3D model 117 of the feature 130. However, in alternate embodiments, the feature 130 can be segmented into any number of model layers depending on specific requirements of an application. Moreover, a thickness of each of the model layers 118 can be equal or different based on specific requirements of an application. Further, the processing device 104 can also slice the 3D model 117 of the feature 130 based on a set of user instructions received, via the GUI.

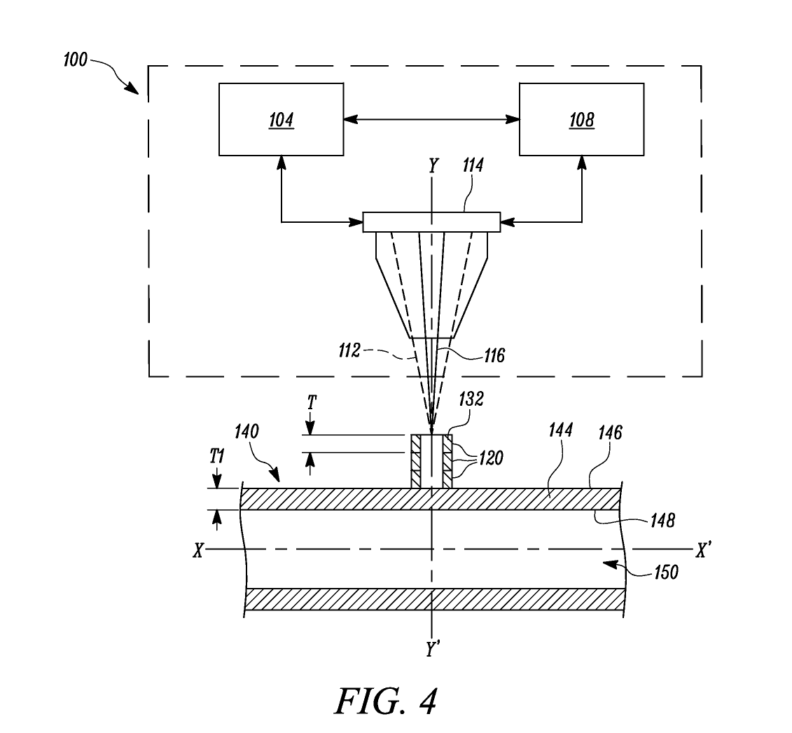

At step 206, the method 200 includes regulating, via the processing device 104, the dispensing member 108 to deposit a plurality of layers 120 of the material on the outer surface 146 of the tube 140 to form the feature 130. Referring to FIG. 4, the processing device 104 actuates the dispensing member 108 to deposit the layers 120 of the material corresponding to the model layers 118 generated by the processing device 104. Upon actuation, the dispensing member 108 delivers the stream 112 of the material at the predetermined work area on the outer surface 146 of the tube 140. The material can be in the form of a powder or a wire. Further, the dispensing member 108 can deposit each layer 118 of the material periodically or continuously.

The dispensing member 108 is aligned with the transverse axis YY′. The dispensing member 108 can be configured to move away from the tube 140 along the transverse axis YY′. Simultaneously, the dispensing member 108 can also be configured to rotate about the transverse axis YY′ to deposit the layers 120 of the material. For example, the dispensing member 108 can be mounted on a robotic arm (not shown) that facilitates the desired movement of the dispensing member 108. Further, a rate of dispensing the material can be varied depending on various parameters, such as a diameter of the tube 140, the thickness ‘T’ of the first wall 144, and the height and diameter of the feature 130.

As shown in FIG. 4, based on the length “L” of the model layers 118, the dispensing member 108 deposits each layer 120 corresponding to the model layers 116. At this point, a portion of the feature 130 that correspond to three such layers has been formed. Referring to FIG. 5, upon completion of the feature in part by the dispensing member 108, the processing device 104 can be configured to stop the dispensing member 108.

At step 208, the method 200 includes forming, via a machining process, the hole 160 in the first wall 144 of the tube 140 to communicate an interior of the feature 130 with an interior of the tube 140. Referring to FIG. 6, the hole 160 is formed extending between the outer surface 146 and the inner surface 148 of the tube 140 to communicate the first interior cavity 150 with the second interior cavity 138. The hole 160 can be formed via various manufacturing methods, such as drilling, boring or punching.

### INDUSTRIAL APPLICABILITY

The present disclosure is related to the method 200 of forming the feature 130 on the tube 140. As described above, the 3D model 117 of the feature 130 is formed via the processing device 104. The 3D model 117 is sliced into the model layers 118 that are located above one another. After slicing of the 3D model 117 of the feature 130 into the model layers 118, deposition of the layers 120 is initiated at a predetermined location on the outer surface 146 of the tube 140. The hole 160 is formed in the first wall 144 to communicate the second interior cavity 138 of the feature 130 with the first interior cavity 150 of the tube 140. Further, the machining processes such as threading, finishing, honing can also be performed on the feature 130. For example, a threading can be performed on the feature 130 such that the feature 130 can be coupled to another component of the machine.

Further, the method 200 can be used to form a feature of any shape and size depending on an application of the feature. As the method 200 can be computer implemented, the method 200 can also prevent material wastage. The feature 130 can be accurately formed at a lesser cost. The method 200 can also be used to make customized fit between the feature 130 and the tube 140, and thus enable assembly variations for the machine. Moreover, the method 200 also ensures a good metallurgical bond between the feature 130 and the first wall 144 of the tube 140. Thus, a leakage proof joint between the feature 130 and the tube 140 is ensured.

While aspects of the present disclosure have been particularly shown and described with reference to the embodiments above, it will be understood by those skilled in the art that various additional embodiments can be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of forming a feature on a tube having a wall, the wall defining an outer surface and an inner surface, the method comprising:
forming, via a processing device, a Three Dimensional (3D) model of the feature;
slicing, via the processing device, the 3D model of the feature into a plurality of model layers;
regulating, via the processing device, a dispensing member to deposit a plurality of layers of a material on the outer surface of the tube to form the feature, wherein the plurality of layers of the material correspond to the plurality of model layers; and
forming, via a machining process, a hole in the wall of the tube to communicate an interior of the feature with an interior of the tube.
